(19) United States
(12) Patent Application Publication
(10) Pub. No.: US 2024/0022902 A1
(43) Pub. Date: Jan. 18, 2024

(54) Receiver Verification of Shared Credentials

(71) Applicant: Apple Inc., Cupertino, CA (US)

(72) Inventors: Matthias Lerch, San Francisco, CA (US); Benjamin D. Chester, San Jose, CA (US); Matthew C. Byington, San Jose, CA (US)

(21) Appl. No.: 18/352,799

(22) Filed: Jul. 14, 2023

Related U.S. Application Data
(60) Provisional application No. 63/390,182, filed on Jul. 18, 2022.

(51) Int. Cl. H04W 12/03; H04W 12/06

(52) U.S. Cl. CPC H04W 12/03; H04W 12/06

(57) ABSTRACT

During operation, a host computer may receive, associated with an electronic device, contact information of a user of the electronic device and input data for a hash function. Then, the host computer may verify the electronic device based at least in part on an identifier of the electronic device and stored device information. Alternatively, the host computer may jointly perform a verification process with a verification computer to verify the electronic device. Next, the host computer may generate a hashed version of the contact information based at least in part on the input data and the hash function. Moreover, the host computer may provide, addressed to a partner computer, the hashed contact information and a request for the provisioning data. Furthermore, the host computer may selectively receive, associated with the partner computer, the provisioning data, and the host computer may selectively provide, addressed to the electronic device, the provisioning data.

### CROSS-REFERENCE TO RELATED APPLICATION

This application claims the benefit of U.S. Provisional Application No. 63/390,182, entitled “Receiver Verification of Shared Credentials,” filed Jul. 18, 2022, the contents of which are hereby incorporated by reference.

### FIELD

The described embodiments relate, generally, to wireless communications among electronic devices, including techniques for verifying a receiver of shared credential, such as a secure digital key.

### BACKGROUND

There is increased interest from in the use secure digital keys. For example, in recent years some vehicle manufacturers have implemented or supported the use of secure digital car keys, such as digital car keys that are compatible with protocols defined by the Car Connectivity Consortium® or CCC (of Beaverton, Oregon). Notably, after a user (such as an owner of a vehicle) performs a car-key-pairing procedure between an electronic device (such as the user's cellular telephone) and the vehicle, the user may use the electronic device as a digital car key for the vehicle via wireless communication. This capability may allow the electronic device to supplement or to replace the use of a separate key fob.

However, the availability of digital car keys poses additional challenges. For example, it is difficult for the user to share or transfer a digital car key to other individuals. Notably, in existing share procedures, sharing a digital car key from the owner to a receiver (such as an electronic device associated with a family member, a friend, a valet, a towing service or a mechanic, who is sometimes referred to as a ‘recipient’) is often inconvenient, complicated (e.g., may involve the use of multiple communication channels) and increases security risks that the shared digital key may be intercepted, may not reach the intended recipient, that the shared digital key may be forwarding by the recipient to an unintended recipient, or that the recipient leaves their electronic device unintended and an attacker forwards the shared digital key without the recipient's knowledge. Similar problems occur in existing share procedures for other types of digital keys, such as a digital house key or digital lock key. Consequently, the existing share procedures are frustrating to users and decrease the likelihood that users will take advantage of digital keys and associated services.

### SUMMARY

In a first group of embodiments, an electronic device that receives a set of provisioning data for creating an instance of a digital key is described. This electronic device includes: an interface circuit that communicates with a second electronic device, a relay computer, and a host computer; a processor; and memory storing program instructions. During operation, the electronic device receives, associated with the second electronic device, an invitation to receive the instance of the digital key, where the invitation includes an encryption key and an address of the relay computer. In response to an instruction or a command accepting the invitation, the electronic device provides, addressed to the relay computer, a request for contact information of the electronic device and first provisioning data for the instance of the digital key. After receiving, associated with the relay computer, encrypted information specifying the contact information and the first provisioning data, the electronic device decrypts the encrypted information. Then, the electronic device provides, addressed to the host computer, second contact information and input data for a hash function. Next, the electronic device selectively receives, associated with the host computer, second provisioning data for the instance of the digital key.

Note that the input data may include a salt (such as random or pseudorandom data).

Moreover, after providing the contact information and the input data, and prior to receiving the second provisioning data, the electronic device may perform a verification process, e.g., with the host computer and a verification computer. For example, the verification process may include a challenge-and-a-response process (which is sometimes referred to as a ‘one-time password authentication’).

Furthermore, after receiving the second provisioning data, the electronic device may create the instance of the digital key based at least in part on the first provisioning data and the second provisioning data.

Additionally, the contact information may include a telephone number and/or an email address of the user. In some embodiments, the contact information may include multiple telephone numbers and/or multiple email addresses of the user. In these embodiments, the electronic device may receive a user-selection of one of the telephone numbers and/or one of the email addresses, and the second contact information may include the selected one of the telephone numbers and/or the one of the email addresses.

Moreover, the invitation may include a link corresponding to the address of the relay computer, and the instruction or the command accepting the invitation may include or may be associated with activation of the link.

Furthermore, the instance of the digital key may include a digital car key or a digital lock key.

Additionally, the relay computer may be associated with a different manufacturer or a provider than a manufacturer or a provider of the electronic device. For example, the relay computer may be associated with a manufacturer or a provider of the second electronic device. In some embodiments, the host computer and/or the verification computer may be associated with the manufacturer or the provider of the electronic device. Moreover, the second electronic device may be associated with an owner of the digital key.

Other embodiments provide the second electronic device that performs counterpart operations to at least some of the operations performed by the electronic device.

Other embodiments provide the relay computer that performs counterpart operations to at least some of the operations performed by the electronic device.

Other embodiments provide the host computer that performs counterpart operations to at least some of the operations performed by the electronic device.

Other embodiments provide the verification computer that performs counterpart operations to at least some of the operations performed by the electronic device.

Other embodiments provide an integrated circuit for use with the electronic device or the second electronic device. The integrated circuit may perform at least some of the aforementioned operations.

Other embodiments provide a computer-readable storage medium for use with the electronic device, the second electronic device, the relay computer, the host computer, or the verification computer. When program instructions stored in the computer-readable storage medium are executed by the electronic device, the second electronic device, the relay computer, the host computer, or the verification computer, the program instructions may cause the electronic device, the second electronic device, the relay computer, the host computer, or the verification computer to perform at least some of the aforementioned operations of the electronic device, the second electronic device, the relay computer, the host computer, or the verification computer.

Other embodiments provide a method. The method includes at least some of the aforementioned operations performed by the electronic device, the second electronic device, the relay computer, the host computer, or the verification computer.

In a second group of embodiments, a host computer that provides provisioning data for creating an instance of a digital key is described. This electronic device includes: an interface circuit that communicates with an electronic device, a verification computer and a partner computer; a processor; and memory storing program instructions. During operation, the host computer receives, associated with the electronic device, contact information of a user of the electronic device and input data for a hash function. Then, the host computer performs a comparison operation based at least in part on an identifier of the electronic device and stored device information. When there is a match between the identifier and the stored device information, the host computer considers the electronic device to be verified. Alternatively, when there is not a match between the identifier and the stored device information, the host computer provides a request, addressed to the verification computer, with a one-time password to be provided to the electronic device, and receives, associated with the electronic device, the one-time password that is then used by the host computer to verify the electronic device. Next, the host computer generates a hashed version of the contact information based at least in part on the input data and the hash function. Moreover, the host computer provides, addressed to the partner computer, the hashed contact information and a request for the provisioning data. Furthermore, the host computer selectively receives, associated with the partner computer, the provisioning data, and the host computer selectively provides, addressed to the electronic device, the provisioning data.

Note that the contact information may include a telephone number or an email address of the user.

Moreover, the input data may include a salt (such as random or pseudorandom data).

Furthermore, the instance of the digital key may include a digital car key or a digital lock key.

Additionally, the partner computer may be associated with a manufacturer that provides the instance of the digital key. In some embodiments, the host computer and/or the verification computer may be associated with a manufacturer or a provider of the electronic device.

Other embodiments provide the electronic device that performs counterpart operations to at least some of the operations performed by the electronic device.

Other embodiments provide the verification computer that performs counterpart operations to at least some of the operations performed by the electronic device.

Other embodiments provide the partner computer that performs counterpart operations to at least some of the operations performed by the electronic device.

Other embodiments provide an integrated circuit for use with the electronic device. The integrated circuit may perform counterpart operations to at least some of the aforementioned operations.

Other embodiments provide a computer-readable storage medium for use with the electronic device, the host computer, the verification computer or the partner computer. When program instructions stored in the computer-readable storage medium are executed by the electronic device, the host computer, the verification computer or the partner computer, the program instructions may cause the electronic device, the host computer, the verification computer or the partner computer to perform at least some of the aforementioned operations of the electronic device, the host computer, the verification computer or the partner computer.

Other embodiments provide a method. The method includes at least some of the aforementioned operations performed by the electronic device, the host computer, the verification computer or the partner computer.

This Summary is provided for purposes of illustrating some exemplary embodiments, so as to provide a basic understanding of some aspects of the subject matter described herein. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The included drawings are for illustrative purposes and serve only to provide examples of possible structures and arrangements for the disclosed systems and techniques for intelligently and efficiently managing communication between multiple associated user devices. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1 illustrates an example of communication between electronic devices according to some embodiments of the disclosure.

FIG. 2 illustrates an example method for receiving a set of provisioning data for creating an instance of a digital key according to some embodiments of the disclosure.

FIG. 3 illustrates an example method for providing provisioning data for creating an instance of a digital key according to some embodiments of the disclosure.

FIG. 4 illustrates an example of communication among components, e.g., in the electronic devices of FIG. 1 according to some embodiments of the disclosure.

FIG. 5 illustrates an example of an electronic device of FIG. 1 according to some embodiments of the disclosure.

Note that like reference numerals refer to corresponding parts throughout the drawings. Moreover, multiple instances of the same part are designated by a common prefix separated from an instance number by a dash.

### DETAILED DESCRIPTION

A first group of embodiments includes an electronic device that receives a set of provisioning data for creating an instance of a digital key is described. During operation, the electronic device may receive, associated with a second electronic device, an invitation to receive the instance of the digital key, where the invitation includes an encryption key and an address of a relay computer. In response to an instruction or a command accepting the invitation, the electronic device may provide, addressed to a relay computer, a request for contact information of the electronic device and first provisioning data for the instance of the digital key. After receiving, associated with the relay computer, encrypted information specifying the contact information and the first provisioning data, the electronic device may decrypt the encrypted information. Then, the electronic device may provide, addressed to a host computer, second contact information and input data for a hash function. Next, the electronic device may selectively receive, associated with the host computer, second provisioning data for the instance of the digital key.

A second group of embodiments includes a host computer that provides provisioning data for creating an instance of a digital key is described. During operation, the host computer may receive, associated with an electronic device, contact information of a user of the electronic device and input data for a hash function. Then, the host computer may perform a comparison operation based at least in part on an identifier of the electronic device and stored device information. When there is a match between the identifier and the stored device information, the host computer may consider the electronic device to be verified. Alternatively, when there is not a match between the identifier and the stored device information, the host computer may provide a request, addressed to the verification computer, with a one-time password to be provided to the electronic device, and may receive, associated with the electronic device, the one-time password that is then used by the host computer to verify the electronic device. Next, the host computer may generate a hashed version of the contact information based at least in part on the input data and the hash function. Moreover, the host computer may provide, addressed to a partner computer, the hashed contact information and a request for the provisioning data. Furthermore, the host computer may selectively receive, associated with the partner computer, the provisioning data, and the host computer may selectively provide, addressed to the electronic device, the provisioning data.

By selectively exchanging the set of provisioning data based at least in part on the hashed version of the contact information, these communication techniques may facilitate secure communication of the instance of the digital key. Notably, the communication techniques may ensure that the instance of the digital key is delivered to the intended receiver (the electronic device). Moreover, the communication techniques may eliminate the need for multiple communication channels or additional manual action by the user of the electronic device (notably, between the electronic devices of the owner and the recipient, but there still may be multiple communication channels used verify the contact information of the recipient). Consequently, the communication techniques may more convenient, less complicated, and more secure than existing approaches for sharing digital keys. Therefore, the communication techniques may improve the user experience, which may encourage potential users to take advantage of or to use digital keys and associated services.

In the discussion that follows, a user may include: an individual, an organization, a company, a governmental agency, a for-profit business entity, a not-for-profit entity, or a group of one or more individuals.

Note that the communication techniques may be used during or with wired or wireless communication between electronic devices in accordance with a communication protocol, such as a communication protocol that is compatible with an IEEE 802.11 standard (which is sometimes referred to as Wi-Fi). However, this communication techniques may also be used with a wide variety of other communication protocols, and in electronic devices (such as portable electronic devices or mobile devices) that can incorporate multiple different radio access technologies (RATs) to provide connections through different wireless networks that offer different services and/or capabilities.

An electronic device can include hardware and software to support a wireless personal area network (WPAN) according to a WPAN communication protocol, such as those standardized by the Bluetooth Special Interest Group and/or those developed by Apple (in Cupertino, California) that are referred to as an Apple Wireless Direct Link (AWDL). Moreover, the electronic device can communicate via: a wireless wide area network (WWAN), a wireless metro area network (WMAN), a WLAN, near-field communication (NFC), a cellular-telephone or data network (such as using a third generation (3G) communication protocol, a fourth generation (4G) communication protocol, e.g., Long Term Evolution or LTE, LTE Advanced (LTE-A), a fifth generation (5G) communication protocol, or other present or future developed advanced cellular communication protocol) and/or another communication protocol. In some embodiments, the communication protocol includes a peer-to-peer communication technique.

The electronic device, in some embodiments, can also operate as part of a wireless communication system, which can include a set of client devices, which can also be referred to as stations or client electronic devices, interconnected to an access point, e.g., as part of a WLAN, and/or to each other, e.g., as part of a WPAN and/or an ‘ad hoc’ wireless network, such as a Wi-Fi direct connection. In some embodiments, the client device can be any electronic device that is capable of communicating via a WLAN technology, e.g., in accordance with a WLAN communication protocol. Furthermore, in some embodiments, the WLAN technology can include a Wi-Fi (or more generically a WLAN) wireless communication subsystem or radio, and the Wi-Fi radio can implement an IEEE 802.11 technology, such as one or more of: IEEE 802.11a; IEEE 802.11b; IEEE 802.11g; IEEE 802.11-2007; IEEE 802.11n; IEEE 802.11-2012; IEEE 802.11-2016; IEEE 802.11ac; IEEE 802.11ax, IEEE 802.11ba, IEEE 802.11be, or other present or future developed IEEE 802.11 technologies.

Note that the electronic device may use multi-user transmission (such as OFDMA) and/or multiple-input multiple-output (MIMO).

In some embodiments, the electronic device can act as a communications hub that provides access to a WLAN and/or to a WWAN and, thus, to a wide variety of services that can be supported by various applications executing on the electronic device. Thus, the electronic device may include an ‘access point’ that communicates wirelessly with other electronic devices (such as using Wi-Fi), and that provides access to another network (such as the Internet) via IEEE 802.3 (which is sometimes referred to as ‘Ethernet’). Note that the access point may be a physical access point or a virtual or ‘software’ access point that is implemented on a computer or an electronic device. However, in other embodiments the electronic device may not be an access point.

Additionally, it should be understood that the electronic devices described herein may be configured as multi-mode wireless communication devices that are also capable of communicating via different 3G and/or second generation (2G) RATs. In these scenarios, a multi-mode electronic device or UE can be configured to prefer attachment to LTE networks offering faster data rate throughput, as compared to other 3G legacy networks offering lower data rate throughputs. For example, in some implementations, a multi-mode electronic device is configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable. More generally, the electronic devices described herein may be capable of communicating with other present or future developed cellular-telephone technologies.

In accordance with various embodiments described herein, the terms ‘wireless communication device,’ ‘electronic device,’ ‘mobile device,’ ‘mobile station,’ ‘wireless station,’‘wireless access point,’ ‘station,’ ‘access point’ and ‘user equipment’ (UE) may be used herein to describe one or more consumer electronic devices that may be capable of performing procedures associated with various embodiments of the disclosure.

In the discussion that follows, a digital car key is used as an illustration of the communication techniques. However, in other embodiments, the communication techniques may be used with a wide variety of types of digital keys, such as a digital lock key (e.g., of a home, an apartment, an office, a multi-family home, such as an apartment building where multiple parties need to use the same door to the lobby, etc.) in applications such as consumer, hospitality and/or rental.

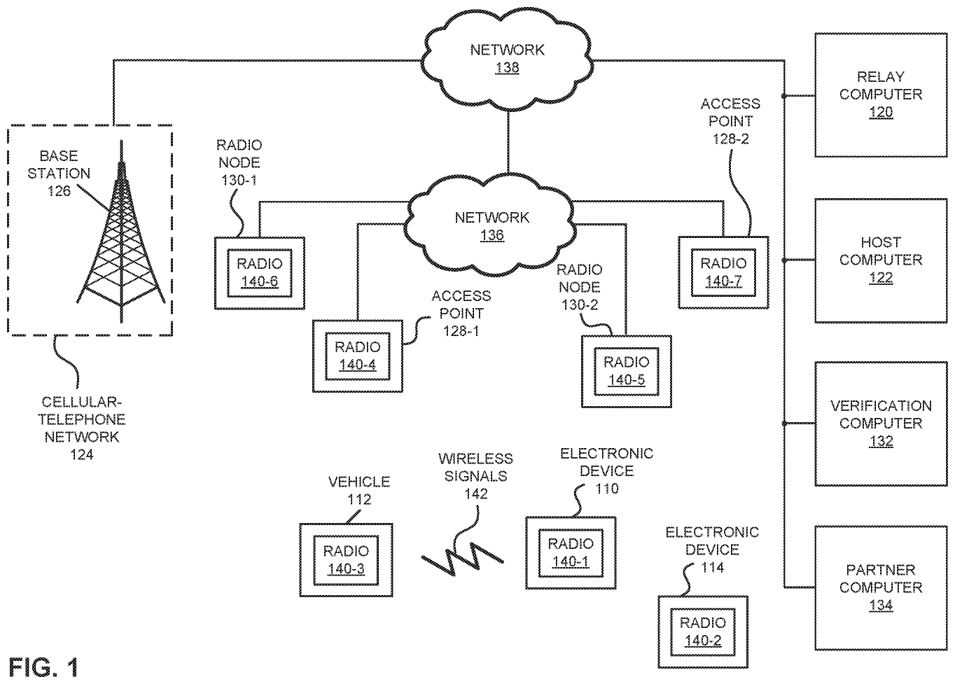

FIG. 1 presents a block diagram illustrating an example of electronic devices that communicate using wired and/or wireless communication. Notably, a car-key pairing may have been established between an electronic device 110 (such as a smartphone, a laptop computer, a notebook computer, a tablet, or another such electronic device) and vehicle 112 (such as a car, a truck, a bus, a bicycle, a moped, a motorcycle, etc.). Based at least in part on the car-key pairing, electronic device 110 may function as a digital car key for vehicle 112 by communicating wirelessly using a Bluetooth or a Bluetooth Low Energy communication protocol or a near-field communication protocol. Note that in the present discussion a ‘digital car key’ may have similar capabilities as a key fob (e.g., a remote-control device that controls a remote keyless entry system and/or that enables a remote vehicle ignition system). However, unlike a key fob, electronic device 110 may not be dedicated solely to the digital car key functionality (e.g., electronic device 110 may also be used for one or more different functions than those associated with a digital car key). In some embodiments, the digital car key may be compatible with a standard or a specification from the Car Connectivity Consortium.

Moreover, electronic device 110 and electronic device 114 may communicate with one or more electronic devices and/or one or more computers (such as relay computer 120, host computer 122, verification computer 132 and/or partner computer 134) using wired and/or wireless communication. Notably, the communication may occur: directly (such as when electronic device 110 is within wireless range of another electronic device, such as electronic device 114), or via a cellular-telephone network 124 (which may include a base station 126), one or more access points 128 (which may communicate using Wi-Fi) in a WLAN and/or one or more radio nodes 130 (which may communicate using LTE or a 5G cellular-telephone communication protocol) in a small-scale network (such as a small cell). For example, the one or more radio nodes 130 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. Note that one or more base stations (such as base station 126), access points 128, and/or radio nodes 130 may be included in one or more wireless networks, such as: a WLAN, a small cell, and/or a cellular-telephone network.

Access points 128 and/or radio nodes 130 may communicate with each other, relay computer 120 (such as a local or a cloud-based computer system that includes one or more computers), host computer 122 (such as a local or a cloud-based computer system that includes one or more computers), verification computer 132 (such as a local or a cloud-based computer system that includes one or more computers), and/or partner computer 134 (such as a local or a cloud-based computer system that includes one or more computers) using a wired communication protocol (such as Ethernet) via network 136 and/or 138. However, in some embodiments, access points 128 and/or radio nodes 130 may communicate with each other using wireless communication (such as Wi-Fi, Bluetooth and/or another wireless communication protocols), e.g., one of access points 128 may be a mesh access point in a mesh network. Note that networks 136 and 138 may be the same or different networks. For example, networks 136 and/or 138 may an LAN, an intra-net or the Internet.

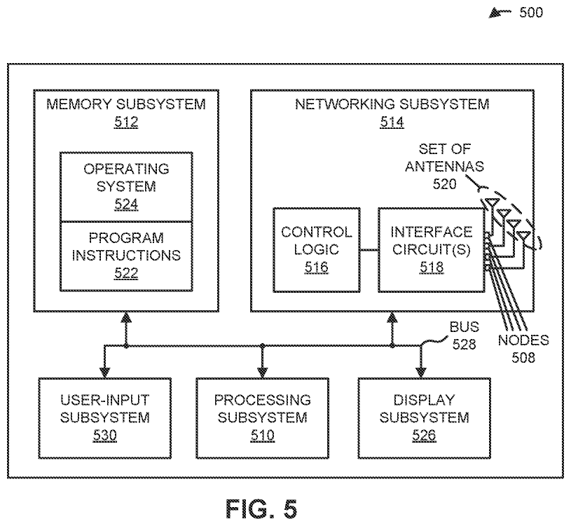

As described further below with reference to FIG. 5, electronic device 110, vehicle 112, electronic device 114, relay computer 120, host computer 122, verification computer 132 and/or partner computer 134 may include subsystems, such as a networking subsystem, a memory subsystem, and a processor subsystem. In addition, electronic device 110, vehicle 112 and electronic device 114, access points 128 and radio nodes 130 may include radios 140 in the networking subsystems. More generally, electronic device 110, vehicle 112 and electronic device 114, access points 128 and radio nodes 130 can include (or can be included within) any electronic devices with networking subsystems that enable electronic device 110, vehicle 112 and electronic device 114, access points 128 and radio nodes 130, respectively, to wirelessly communicate with another electronic device. This can include transmitting frames or beacons on wireless channels to enable the electronic devices to make initial contact with or to detect each other, followed by exchanging subsequent data/management frames (such as connect requests) to establish a connection, configure security options (e.g., IPSec), transmit and receive packets or frames via the connection, etc.

As can be seen in FIG. 1, wireless signals 142 (represented by a jagged line) are communicated by one or more radios 140-1 and 140-2 in electronic device 110 and electronic device 114, respectively. For example, one or more radios 140-1 may receive wireless signals 142 that are transmitted by one or more radios 140-2 via one or more connections between electronic device 110 and electronic device 114. Alternatively, the one or more radios 140-1 may transmit wireless signals 142 that are received by the one or more radios 140-2. The wireless signals 142 may convey one or more packets or frames. However, in embodiments where electronic devices 110 and 114 are not in wireless range of each other, electronic devices 110 and 114 may communicate using other components in FIG. 1.

During the communication in FIG. 1, electronic device 110, vehicle 112 and electronic device 114, access points 128 and radio nodes 130 may wired and/or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include additional information, such as data, as payloads).

As discussed previously, it can be difficult to securely share a digital key, such as a digital car key. For example, when an instance of the digital key is shared between electronic devices from different manufacturers or providers (such as Apple, Inc. and Alphabet, Inc. of Mountain View, California), it can be difficult to confirm that the instance of the shared digital key is received by a designated receiver (such as electronic device 114). Notably, there are security concerns raised by the communication over public networks, as well as the possibility that information corresponding to the instance of the digital key (such as a location where the instance of the digital shared key can be accessed) may be unintentionally shown or shared by a user of the designated receiver to other unintended recipients. While these problems can be reduced by using two-factor verification of the user of the receiver, this typically involves the use of multiple independent communication channels and additional manual actions by the user of the designated receiver. Consequently, these existing approaches are more complicated and inconvenient, and are subject to more security concerns.

In order to address these challenges, in some embodiments of the disclosed communication techniques electronic device 110 may be used to securely share a digital car key installed on electronic device 110 with electronic device 114, where electronic device 114 may be associated with a different manufacturer or provider than a manufacturer or a provider of electronic device 110. Notably, a user of electronic device 110 (such as an owner of vehicle 112) may select recipient contact information (RCI) from contact information (such as one or more email addresses and/or telephone numbers) stored on or associated with electronic device 110. For example, the user of electronic device 110 may select the RCI of a user of electronic device 114 or may select RCI that does not belong to electronic device 114 (or target account), such as an office telephone number. Alternatively, the user of electronic device 110 may provide the RCI of the user of electronic device 114 via a user interface (such as a touch-sensitive display, another human-interface device, a voice-recognition engine, etc.).

Then, electronic device 110 may generated a hashed version of the RCI (which is referred to as ‘RCH’) in order to secure and anonymize the RCI. For example, the RCH may be generated from the RCI using input data (such as a random or a pseudorandom number, which is sometimes referred to as a ‘salt’) and a hash function (which may be known to electronic device 110 and host computer 122, or may be subsequently provided, directly or indirectly, to host computer 122 during the communication techniques). Note that the salt may have high entropy and may be generated by electronic device 110. The salt may ensure that, for multiple shares to the same electronic device, the hashed values are different, so that partner computer 134 cannot determine from the RCH that the shares of two instances of digital car keys from different owners were for the same receiver (or recipient).

Moreover, electronic device 110 may provide the RCH to partner computer 134 (such as a computer associated with a provider or a manufacturer of vehicle 112 and of a digital key for vehicle 112) via relay computer 120. Partner computer 134 may store the RCH and may associate or bind it to the shared asset (such as the instance of the digital key) and/or vehicle 112, and partner computer 134 may provide a reference (such as a bearer token, e.g., an identifier of vehicle 112 or, in other embodiments, an identifier of a hotel room) to the shared asset to electronic device 110 via relay computer 120. In some embodiments, the binding of the RCH to the shared asset may have a limited lifetime, so that the sharing of the instance of the digital car key needs to be completed with a time interval, such as an hour or a day. Then, electronic device 110 may generate an encryption key (such as a symmetric encryption key), may encrypt the RCI, and may provide the encrypted RCI and the input data to relay computer 120. Note that relay computer 120 may be associated with the same manufacturer or provider as electronic device 114.

Next, electronic device 110 may provide, addressed to electronic device 114, an invitation to receive the instance of the digital key, where the invitation includes the encryption key and an address of relay computer 120. For example, the invitation may include a pointer to an address or location (such as a uniform resource locator or URL) of relay computer 120. Alternatively, the invitation may include the address of relay computer 120. Note that the invitation may be communicated using a side message system (SMS) or text messaging service, in which case relay computer 120 may be an Internet database access server.

In response to an instruction or a command accepting the invitation (e.g., the user of electronic device 114 may click on or activate a link or virtual icon in the invitation), electronic device 114 may provide, addressed to relay computer 120, a request for the RCI of the user of electronic device 114 and first provisioning data for the instance of the digital key. Then, relay computer 120 may provide the RCI and the first provisioning data to electronic device 114. Note that the first provisioning data may include the input data and car-key creation data, which may be used to create the instance of the digital car key. For example, as described further below, the first provisioning data may be used, at least in part, to directly or indirectly create the instance of the digital car key, such as in a secure enclave processor and associated secure memory in electronic device 114.

After receiving the RCI and the first provisioning data, electronic device 114 may decrypt the encrypted RCI using the encryption key to recover the RCI. In embodiments where the RCI includes multiple telephone numbers and/or multiple email addresses of the user of electronic device 114, electronic device 114 may present the RCI to the user (e.g., on a display) and may receive (via a touch-sensitive display, another human interface device, a voice-recognition engine, etc.) a user-selection of one of the telephone numbers and/or one of the email addresses, which may be subsequently used when communicating with electronic device 114, such as when providing second provisioning data for the instance of the digital key to electronic device 114.

Moreover, electronic device 114 may provide, addressed to host computer 122, the RCI and the input data. After receiving the RCI and the input data, host computer 122 may verify electronic device 114 based at least in part on an identifier of or associated with electronic device 114 (such as a media access control or MAC address, a telephone number, an email address, etc.) and stored device information about electronic device 114. Notably, in some embodiments, host computer 122 may be associated with a manufacturer or a provider of electronic device 114, and electronic device 114 may be pre-registered with host computer 122. Therefore, in some embodiments, host computer 122 may verify electronic device 114 by performing a comparison operation based at least in part on the identifier of or associated with electronic device 114 and the stored device information. When there is a match between the identifier and the stored device information, host computer 122 may consider electronic device 114 to be verified.

Alternatively, when there is not a match between the identifier and the stored device information, host computer 122 may jointly perform a verification process (which is sometimes referred to as a challenge-and-a-response process or one-time password authentication) of electronic device 114 with verification computer 132. Notably, host computer 122 may provide a request, addressed to verification computer 132, with a one-time password to be provided to electronic device 114. In response, verification computer 132 may provide, addressed to electronic device 114, the one-time password (e.g., via an in-band or an out-of-band communication channel or the same or a different communication technique as is used for other communication with electronic device 114). In some embodiments, the one-time password may include an eight-digit random number. Moreover, after electronic device 114 receives the one-time password, electronic device 114 may provide, addressed to host computer 122, the one-time password. For example, when the one-time password is sent to electronic device 114 using an SMS message or an email, electronic device 114 may automatically extract and autofill the one-time password in a response message to host computer 122 (and, thus, without manual action by the user of electronic device 114). However, in other embodiments, the user of electronic device 114 may manually enter the one-time password into a response message to host computer 122. When the one-time password received by host computer 122 matches the one-time password provided to verification computer 132, host computer 122 may consider electronic device 114 to be verified. Note that verification computer 132 may be associated with the manufacturer or the provider of electronic device 114 and host computer 122.

In some embodiments, host computer 122 may, via relay computer 120, communicate additional information to electronic device 110 that can be used by the owner to facilitate verification of the user of electronic device 114. For example, instead of (or in addition to) the one-time password authentication, the owner is provided the additional information that can be used to verify the user of electronic device 114. Notably, the additional information may be provided by the user of electronic device 114 to host computer 122, and then to electronic device 110 via relay computer 120. This additional information may include a photograph or other contact information that the user of electronic device 114 is willing to share. Then, the owner may verify the user based at least in part on the additional information, and this verification may be provided by electronic device 110 to host computer 122 via relay computer 120. This approach may be useful for situations where the additional information allows the user of electronic device 114 to be uniquely identified.

Additionally, when electronic device 114 has been successfully verified, host computer 122 may generate the RCH from the RCI based at least in part on the input data and the hash function. Note that host computer 122 may have previously been provisioned with the hash function (or information specifying the hash function), or the hash function (or information specifying the hash function) may have been provided by electronic device 110 to relay computer 120, and then to electronic device 114 and host computer 122 during the communication techniques. Moreover, host computer 122 may provide, addressed to partner computer 134, the RCH and a request for the second provisioning data. After receiving the RCH from host computer 122, partner computer 134 may compare it to the stored RCH that is bound or associated with the shared asset (e.g., based at least in part on the bearer token, which may have been provided by electronic device 110 to relay computer 120, and then to electronic device 114 and host computer 122 during the communication techniques). When there is a match, partner computer 134 may selectively provide, addressed to host computer 122, the second provisioning data, and host computer 122 may selectively provide, addressed to electronic device 114, the second provisioning data. In embodiments where the user of electronic device 114 selected a particular telephone number and/or a particular email address to be used during provisioning, the selected telephone number or email address is used when providing the second provisioning data to electronic device 114.

After receiving the second provisioning data, electronic device 114 may create the instance of the digital key based at least in part on the first provisioning data and the second provisioning data. Note that the creation of the instance of the digital car key may be compatible with protocols defined or specified by the CCC. For example, to create an instance of a digital car key there may be 1.5 roundtrips of communication to provision the instance of the digital car key (including a car-key creation request, a car-key signing request, and import request, as per the CCC). For other applications, such as hotel or multi-family home keys (e.g., an apartment or a condominium), the bearer token may be sent ‘one shot’ via relay computer 120. The recipient may redeem the bearer token against the digital key with partner computer 134.

Note that, in general, communication between electronic devices or components in FIG. 1 may be encrypted, may include digital certificates and/or may be digitally signed.

In summary, the communication techniques may facilitate secure, flexible and convenient sharing of the instance of the digital car key for vehicle 112 (and, more generally, an instance of a digital key). Consequently, the communication techniques may improve the user experience, which may encourage potential users to take advantage of or to use digital keys and associated services.

In the described embodiments, processing a packet or a frame in electronic device 110, vehicle 112, electronic device 114, access points 128 and/or radio nodes 130 may include: receiving the wireless signals 142 with the packet or the frame; decoding/extracting the packet or the frame from the received wireless signals 142 to acquire the packet or the frame; and processing the packet or the frame to determine the information contained in the payload of the packet or the frame (such as data in the payload).

In general, the communication via the one or more connections in the communication techniques may be characterized by a variety of communication-performance metrics. For example, the communication-performance metric may include any/all of: an RSSI, a data rate, a data rate for successful communication (which is sometimes referred to as a ‘throughput’), a latency, an error rate (such as a retry or resend rate), a mean-square error of equalized signals relative to an equalization target, inter-symbol interference, multipath interference, a signal-to-noise ratio (SNR), a width of an eye pattern, a ratio of a number of bytes successfully communicated during a time interval (such as a time interval between, e.g., 1 and 10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

Although we describe the network environment shown in FIG. 1 as an example, in alternative embodiments, different numbers and/or types of electronic devices may be present. For example, some embodiments may include more or fewer electronic devices. As another example, in other embodiments, different electronic devices can be transmitting and/or receiving packets or frames. In some embodiments, multiple connections or links may be used during communication with an electronic device (such as electronic device 110 or electronic device 114). Moreover, while electronic device 110 performed operations in the communication techniques, in other embodiments at least some of these operations may be performed by vehicle 112, relay computer 120, host computer 122, verification computer 132 and/or partner computer 134. Consequently, one or more electronic devices or components in FIG. 1 may perform operations in the communication techniques.

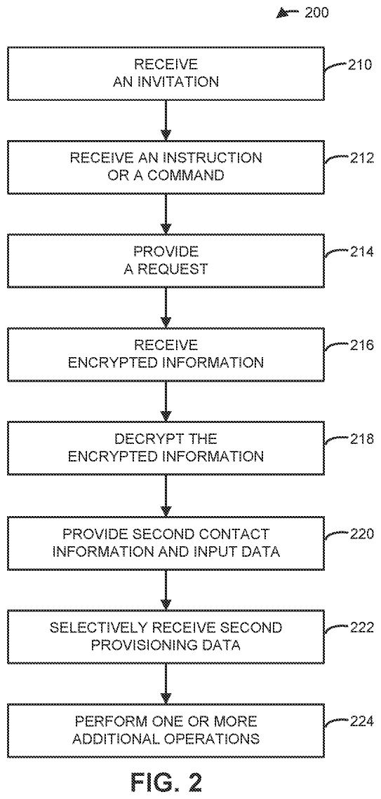

FIG. 2 presents a flow diagram illustrating an example method 200 for receiving a set of provisioning data for creating an instance of a digital key. This method may be performed by an electronic device, such as electronic device 114 in FIG. 1.

During operation, the electronic device may receive, associated with a second electronic device, an invitation (operation 210) to receive the instance of the digital key, where the invitation includes an encryption key and an address of a relay computer. In response to an instruction or a command (operation 212) accepting the invitation, the electronic device may provide, addressed to the relay computer, a request (operation 214) for contact information of a user of the electronic device and first provisioning data for the instance of the digital key. Note that the invitation may include a link corresponding to the address of the relay computer, and the instruction or the command accepting the invitation may include or may be associated with activation of the link. In some embodiments, the instance of the digital key may include a digital car key or a digital lock key.

After receiving, associated with the relay computer, encrypted information (operation 216) specifying the contact information and the first provisioning data, the electronic device may decrypt the encrypted information (operation 218).

Then, the electronic device may provide, addressed to a host computer, second contact information and input data (operation 220) for a hash function. Note that the input data may include a salt (such as random or pseudorandom data).

Next, the electronic device may selectively receive, associated with the host computer, second provisioning data (operation 222) for the instance of the digital key.

In some embodiments, the electronic device optionally performs one or more additional operations (operation 224). Notably, after providing the contact information and the input data (operation 220), and prior to receiving the second provisioning data (operation 222), the electronic device may perform a verification process, e.g., with the host computer and a verification computer. For example, the verification process may include a challenge-and-a-response process (which is sometimes referred to as a ‘one-time password authentication’).

Moreover, after receiving the second provisioning data (operation 222), the electronic device may create the instance of the digital key based at least in part on the first provisioning data and the second provisioning data.

Furthermore, the contact information may include a telephone number and/or an email address of the user. In some embodiments, the contact information may include multiple telephone numbers and/or multiple email addresses of the user. In these embodiments, the electronic device may receive a user-selection of one of the telephone numbers and/or one of the email addresses, and the second contact information may include the selected one of the telephone numbers and/or the one of the email addresses.

Additionally, the relay computer may be associated with a different manufacturer or a provider than a manufacturer or a provider of the electronic device. For example, the relay computer may be associated with a manufacturer or a provider of the second electronic device. In some embodiments, the host computer and/or the verification computer may be associated with the manufacturer or the provider of the electronic device. Moreover, the second electronic device may be associated with an owner of the digital key.

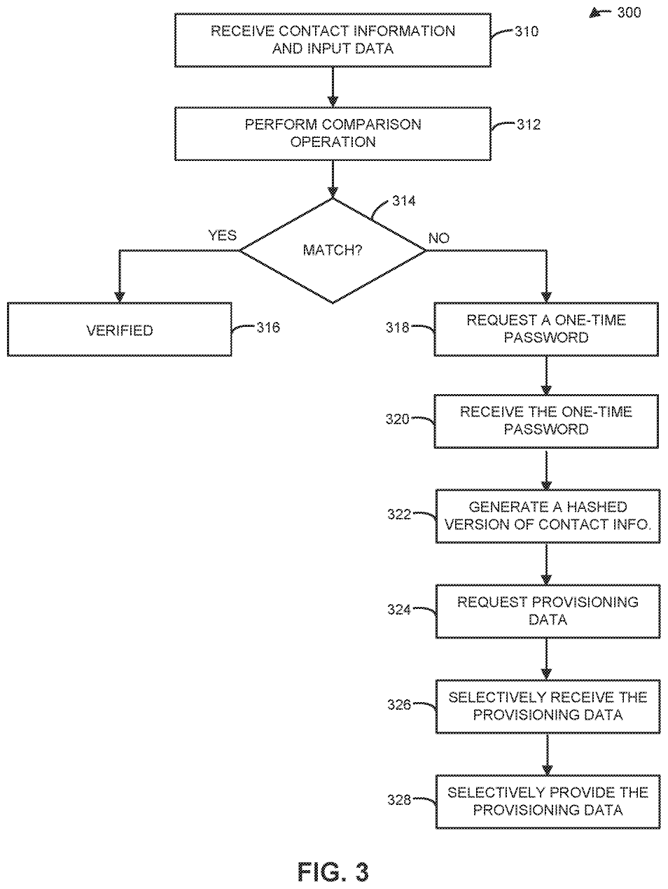

FIG. 3 presents a flow diagram illustrating an example method 300 for providing provisioning data for creating an instance of a digital key. This method may be performed by a host computer, such as host computer 122 in FIG. 1.

During operation, the host computer may receive, associated with an electronic device, contact information of a user of the electronic device and input data (operation 310) for a hash function. Note that the contact information may include a telephone number or an email address of the user. Moreover, the input data may include a salt (such as random or pseudorandom data).

Then, the host computer may perform a comparison operation (operation 312) based at least in part on an identifier of the electronic device and stored device information. When there is a match between the identifier and the stored device information (operation 314), the host computer may consider the electronic device to be verified (operation 316).

Alternatively, when there is not a match between the identifier and the stored device information (operation 314), the host computer may provide a request, addressed to a verification computer, with a one-time password (operation 318) to be provided to the electronic device, and may receive, associated with the electronic device, the one-time password (operation 320) that is then used by the host computer to verify the electronic device. Next, the host computer may generate a hashed version of the contact information (operation 322) based at least in part on the input data and the hash function.

Moreover, the host computer may provide, addressed to a partner computer, the hashed contact information and a request for the provisioning data (operation 324). Furthermore, the host computer may selectively receive, associated with the partner computer, the provisioning data (operation 326), and the host computer may selectively provide, addressed to the electronic device, the provisioning data (operation 328).

Note that the instance of the digital key may include a digital car key or a digital lock key. Furthermore, the partner computer may be associated with a manufacturer that provides the instance of the digital key. In some embodiments, the host computer and/or the verification computer may be associated with a manufacturer or a provider of the electronic device.

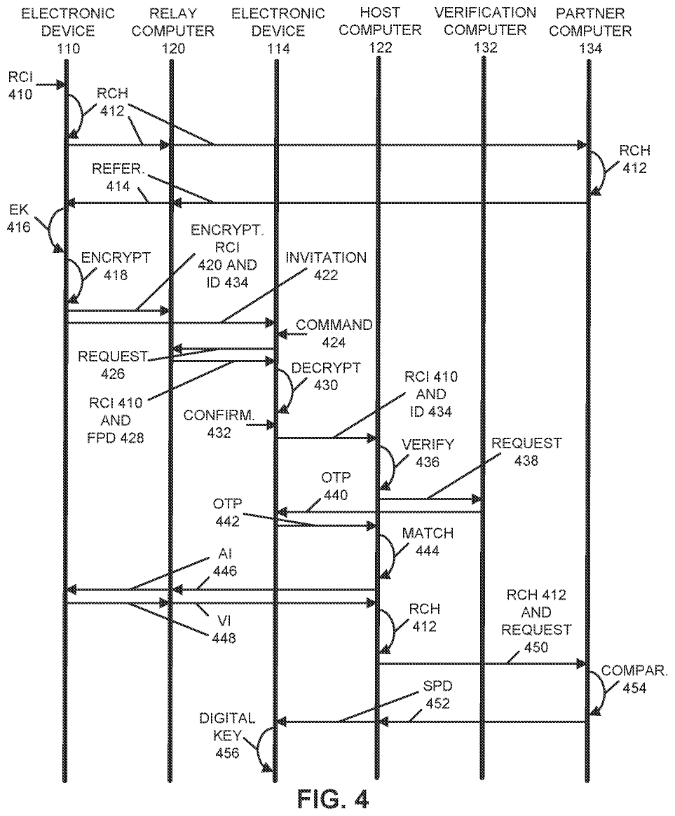

The communication techniques are further illustrated in FIG. 4, which presents a flow diagram illustrating an example of communication among electronic device 110, electronic device 114, relay computer 120, host computer 122, verification computer 132 and partner computer 134. During operation, a user of electronic device 110 may select RCI 410 from contact information (such as one or more email addresses and/or telephone numbers) stored in memory on or associated with electronic device 110. Then, electronic device 110 may generated RCH 412 based at least in part on input data 434 (such as a salt) and a hash function (which may be known to electronic device 110).

Moreover, electronic device 110 may provide the RCH 412 to partner computer 134 (such as a computer associated with a provider or a manufacturer of vehicle 112 and of a digital key for vehicle 112) via relay computer 120. Partner computer 134 may store RCH 412 in memory and may associate or bind it to a shared asset (such as the instance of the digital key) and/or vehicle 112. Then, partner computer 134 may provide a reference 414 (such as a bearer token, e.g., an identifier of vehicle 112) to the shared asset to electronic device 110 via relay computer 120.

Furthermore, electronic device 110 may generate an encryption key (EK) 416, may encrypt 418 RCI 410, and may provide encrypted RCI 420 and input data (ID) 434 to relay computer 120. Next, electronic device 110 may provide, addressed to electronic device 114, an invitation 422 to receive the instance of the digital key, where the invitation includes the encryption key and an address of relay computer 120.

In response to an instruction or a command 424 accepting the invitation (e.g., the user of electronic device 114 may click on or activate a link or virtual icon in the invitation), electronic device 114 may provide, addressed to relay computer 120, a request 426 for RCI 410 of the user of electronic device 114 and first provisioning data 428 for the instance of the digital key. Then, relay computer 120 may provide RCI 410 and first provisioning data (FPD) 428 (such as input data 434 and car-key creation data) to electronic device 114.

After receiving RCI 410 and first provisioning data 428, electronic device 114 may decrypt 430 encrypted RCI 420 using encryption key 416 to recover RCI 410. Moreover, electronic device 114 may optionally receive confirmation 432 (e.g., from the user of electronic device 114) that RCI 410 should be used when communicating with electronic device 114.

Moreover, electronic device 114 may provide, addressed to host computer 122, RCI 410 and input data 434. After receiving RCI 410 and input data 434, host computer 122 may verify 436 electronic device 114 based at least in part on an identifier of or associated with electronic device 114 and stored device information about electronic device 114. For example, host computer 122 may verify 436 electronic device 114 by performing a comparison operation based at least in part on the identifier of or associated with electronic device 114 and the stored device information. When there is a match between the identifier and the stored device information, host computer 122 may consider electronic device 114 to be verified.

Alternatively, when there is not a match between the identifier and the stored device information, host computer 122 may jointly perform a verification process of electronic device 114 with verification computer 132. Notably, host computer 122 may provide a request 438, addressed to verification computer 132, with a one-time password 440 to be provided to electronic device 114. In response, verification computer 132 may provide, addressed to electronic device 114, one-time password (OTP) 440. Moreover, after electronic device 114 receives one-time password 440, electronic device 114 may provide, addressed to host computer 122, one-time password 442. When one-time password 442 received by host computer 122 matches 444 one-time password 440 provided to verification computer 132, host computer 122 may consider electronic device 114 to be verified.

In some embodiments, host computer 122 may, via relay computer 120, communicate additional information (AI) 446 to electronic device 110 that can be used by an owner of vehicle 112 to facilitate verification of the user of electronic device 114. For example, instead of (or in addition to) the one-time password authentication, the owner is provided additional information 446 that can be used to verify the user of electronic device 114. Then, the owner may verify the user based at least in part on additional information 446, and verification information (VI) 448 may be provided by electronic device 110 to host computer 122 via relay computer 120.

Additionally, when electronic device 114 has been successfully verified, host computer 122 may generate RCH 412 from RCI 410 based at least in part on input data 434 and the hash function. Note that host computer 122 may have previously been provisioned with the hash function (or information specifying the hash function), or the hash function (or information specifying the hash function) may have been provided by electronic device 110 to relay computer 120, and then to electronic device 114 and host computer 122 during the communication techniques. Moreover, host computer 122 may provide, addressed to partner computer 134, RCH 412 and a request 450 for second provisioning data 452.

After receiving RCH 412 from host computer 122, partner computer 134 may compare 454 it to the stored RCH that is bound or associated with the shared asset (e.g., based at least in part on reference 414, which may have been provided by electronic device 110 to relay computer 120, and then to electronic device 114 and host computer 122 during the communication techniques). When there is a match, partner computer 134 may selectively provide, addressed to host computer 122, second provisioning data (SPD) 452, and host computer 122 may selectively provide, addressed to electronic device 114, second provisioning data 452.

Moreover, after receiving second provisioning data 452, electronic device 114 may create the instance of the digital key 456 based at least in part on the first provisioning data 428 and second provisioning data 452.

While communication between the components in FIG. 4 is illustrated with unilateral or bilateral communication (e.g., lines having a single arrow or dual arrows), in general a given communication operation may be unilateral or bilateral.

Note that the formats of packets or frames communicated during the communication techniques may include more or fewer bits or fields. Alternatively or additionally, the position of information in these packets or frames may be changed. Thus, the order of the fields may be changed.

While the preceding embodiments illustrate embodiments of the communication techniques using channels or frequency sub-bands, in other embodiments the communication techniques may involve the concurrent use of different temporal slots, and/or or a combination of different frequency sub-bands, different frequency bands and/or different temporal slots.

Moreover, while the preceding embodiments illustrated the use of Wi-Fi, a cellular-telephone communication protocol and/or Ethernet in the communication techniques, in other embodiments of the communication techniques another communication protocol (such as Bluetooth or Bluetooth Low Energy) is used to communicate at least a portion of the information in the communication techniques. Furthermore, the information communicated in the communication techniques may be communicated may occur in one or more frequency bands, including: 900 MHz, a 2.4 GHz frequency band, a 5 GHz frequency band, a 6 GHz frequency band, a 7 GHz frequency band, a 60 GHz frequency band, a Citizens Broadband Radio Service (CBRS) frequency band, a band of frequencies used by LTE, etc.

As described herein, aspects of the present technology may include the gathering and use of data available from various sources, e.g., to improve or enhance functionality. The present disclosure contemplates that in some instances, this gathered data may include personal information data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital signs measurements, medication information, exercise information), date of birth, or any other identifying or personal information. The present disclosure recognizes that the use of such personal information data, in the present technology, may be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology may be configurable to allow users to selectively “opt in” or “opt out” of participation in the collection of personal information data, e.g., during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure may broadly cover use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

We now describe embodiments of an electronic device. FIG. 5 presents a block diagram of an electronic device 500 (which may be a cellular telephone, a smartwatch, an access point, an IoT device, a computer, a computer system, a server, another electronic device, etc.) in accordance with some embodiments. This electronic device includes processing subsystem 510, memory subsystem 512 and networking subsystem 514. Processing subsystem 510 includes one or more devices configured to perform computational operations. For example, processing subsystem 510 can include one or more microprocessors, application-specific integrated circuits (ASICs), microcontrollers, graphics processing units (GPUs), programmable-logic devices, and/or one or more digital signal processors (DSPs).

Memory subsystem 512 includes one or more devices for storing data and/or instructions for processing subsystem 510, and/or networking subsystem 514. For example, memory subsystem 512 can include dynamic random access memory (DRAM), static random access memory (SRAM), a read-only memory (ROM), flash memory, and/or other types of memory. In some embodiments, instructions for processing subsystem 510 in memory subsystem 512 include: program instructions or sets of instructions (such as program instructions 522 or operating system 524), which may be executed by processing subsystem 510. For example, a ROM can store programs, utilities or processes to be executed in a non-volatile manner, and DRAM can provide volatile data storage, and may store instructions related to the operation of electronic device 500. Note that the one or more computer programs may constitute a computer-program mechanism, a computer-readable storage medium or software. Moreover, instructions in the various modules in memory subsystem 512 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 510. In some embodiments, the one or more computer programs are distributed over a network-coupled computer system so that the one or more computer programs are stored and executed in a distributed manner.

In addition, memory subsystem 512 can include mechanisms for controlling access to the memory. In some embodiments, memory subsystem 512 includes a memory hierarchy that comprises one or more caches coupled to a memory in electronic device 500. In some of these embodiments, one or more of the caches is located in processing subsystem 510.

In some embodiments, memory subsystem 512 is coupled to one or more high-capacity mass-storage devices (not shown). For example, memory subsystem 512 can be coupled to a magnetic or optical drive, a solid-state drive, or another type of mass-storage device. In these embodiments, memory subsystem 512 can be used by electronic device 500 as fast-access storage for often-used data, while the mass-storage device is used to store less frequently used data.

Networking subsystem 514 includes one or more devices configured to couple to and communicate on a wired and/or wireless network (i.e., to perform network operations), such as: control logic 516, one or more interface circuits 518 and a set of antennas 520 (or antenna elements) in an adaptive array that can be selectively turned on and/or off by control logic 516 to create a variety of optional antenna patterns or ‘beam patterns.’ Alternatively, instead of the set of antennas, in some embodiments electronic device 500 includes one or more nodes 508, e.g., a pad or a connector, which can be coupled to the set of antennas 520. Thus, electronic device 500 may or may not include the set of antennas 520. For example, networking subsystem 514 can include a Bluetooth™ networking system, a cellular networking system (e.g., a 3G/4G/5G network such as UMTS, LTE, etc.), a universal serial bus (USB) networking system, a networking system based on the standards described in IEEE 802.12 (e.g., a Wi-Fi® networking system), an Ethernet networking system, and/or another networking system.

In some embodiments, networking subsystem 514 includes one or more radios, such as a wake-up radio that is used to receive wake-up frames and wake-up beacons, and a main radio that is used to transmit and/or receive frames or packets during a normal operation mode. The wake-up radio and the main radio may be implemented separately (such as using discrete components or separate integrated circuits) or in a common integrated circuit.

Networking subsystem 514 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 500 may use the mechanisms in networking subsystem 514 for performing simple wireless communication between the electronic devices, e.g., transmitting advertising or frame frames and/or scanning for advertising frames transmitted by other electronic devices.

Within electronic device 500, processing subsystem 510, memory subsystem 512 and networking subsystem 514 are coupled together using bus 528 that facilitates data transfer between these components. Bus 528 may include an electrical, optical, and/or electro-optical connection that the subsystems can use to communicate commands and data among one another. Although only one bus 528 is shown for clarity, different embodiments can include a different number or configuration of electrical, optical, and/or electro-optical connections among the subsystems.

In some embodiments, electronic device 500 includes a display subsystem 526 for displaying information on a display, which may include a display driver and the display, such as a liquid-crystal display, a multi-touch touchscreen, etc. Display subsystem 526 may be controlled by processing subsystem 510 to display information to a user (e.g., information relating to incoming, outgoing, or an active communication session).

Electronic device 500 can also include a user-input subsystem 530 that allows a user of the electronic device 500 to interact with electronic device 500. For example, user-input subsystem 530 can take a variety of forms, such as: a button, keypad, dial, touch screen, audio input interface, visual/image capture input interface, input in the form of sensor data, etc.

Electronic device 500 can be (or can be included in) any electronic device with at least one network interface. For example, electronic device 500 may include: a cellular telephone or a smartphone, a tablet computer, a laptop computer, a notebook computer, a personal or desktop computer, a netbook computer, a media player device, a wireless speaker, an IoT device, an electronic book device, a MiFi® device, a smartwatch, a wearable computing device, a portable computing device, a consumer-electronic device, a vehicle, a door, a window, a portal, an access point, a router, a switch, communication equipment, test equipment, as well as any other type of electronic computing device having wireless communication capability that can include communication via one or more wireless communication protocols.

Although specific components are used to describe electronic device 500, in alternative embodiments, different components and/or subsystems may be present in electronic device 500. For example, electronic device 500 may include one or more additional processing subsystems, memory subsystems, networking subsystems, and/or display subsystems. Additionally, one or more of the subsystems may not be present in electronic device 500. Moreover, in some embodiments, electronic device 500 may include one or more additional subsystems that are not shown in FIG. 5. In some embodiments, electronic device may include an analysis subsystem that performs at least some of the operations in the communication techniques. Also, although separate subsystems are shown in FIG. 5, in some embodiments some or all of a given subsystem or component can be integrated into one or more of the other subsystems or component(s) in electronic device 500. For example, in some embodiments program instructions 522 are included in operating system 524 and/or control logic 516 is included in the one or more interface circuits 518.

Moreover, the circuits and components in electronic device 500 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 514. This integrated circuit may include hardware and/or software mechanisms that are used for transmitting wireless signals from electronic device 500 and receiving signals at electronic device 500 from other electronic devices. Aside from the mechanisms herein described, radios are generally known in the art and hence are not described in detail. In general, networking subsystem 514 and/or the integrated circuit can include any number of radios. Note that the radios in multiple-radio embodiments function in a similar way to the described single-radio embodiments.

In some embodiments, networking subsystem 514 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used a Bluetooth or a Bluetooth Low Energy communication protocol as an illustrative example, in other embodiments a wide variety of communication protocols and, more generally, wireless communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 522, operating system 524 (such as a driver for an interface circuit in networking subsystem 514) or in firmware in an interface circuit networking subsystem 514. Alternatively or additionally, at least some of the operations in the communication techniques may be implemented in a physical layer, such as hardware in an interface circuit in networking subsystem 514. In some embodiments, the communication techniques are implemented, at least in part, in a MAC layer and/or in a physical layer in an interface circuit in networking subsystem 514.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an interface circuit configured to communicate with a second electronic device, a relay computer and a host computer;
a processor coupled to the interface circuit; and
memory, coupled to the processor, storing program instructions, wherein, when executed by the processor, the program instructions cause the electronic device to perform operations comprising:
receiving, associated with the second electronic device, an invitation to receive an instance of a digital key, wherein the invitation comprises an encryption key and an address of the relay computer;
providing, addressed to the relay computer, a request for contact information associated with the electronic device and first provisioning data for the instance of the digital key;
receiving, associated with the relay computer, encrypted information specifying the contact information and the first provisioning data;
decrypting the encrypted information;
providing, addressed to the host computer, second contact information and input data for a hash function; and
selectively receiving, associated with the host computer, second provisioning data for the instance of the digital key.

2. The electronic device of claim 1, wherein the input data comprises a random or pseudorandom data.

3. The electronic device of claim 1, wherein, after providing the contact information and the input data, and prior to receiving the second provisioning data, the operations comprise performing a verification process with the host computer and a verification computer.

4. The electronic device of claim 3, wherein the verification process comprises a one-time password authentication.

5. The electronic device of claim 1, wherein, after receiving the second provisioning data, the operations comprise creating the instance of the digital key based at least in part on the first provisioning data and the second provisioning data.

6. The electronic device of claim 1, wherein the contact information comprises at least one of a telephone number or an email address.

7. The electronic device of claim 1, wherein the invitation comprises a link corresponding to the address of the relay computer.

8. The electronic device of claim 1, wherein the instance of the digital key comprises a digital car key or a digital lock key.

9. The electronic device of claim 1, wherein the relay computer is associated with a different manufacturer or a provider than a manufacturer or a provider of the electronic device.

10. The electronic device of claim 9, wherein the relay computer is associated with a manufacturer or a provider of the second electronic device.

11. A method for receiving a set of provisioning data for creating an instance of a digital key, comprising:
by an electronic device:
receiving, associated with a second electronic device, an invitation to receive the instance of the digital key, wherein the invitation comprises an encryption key and an address of a relay computer;
providing, addressed to the relay computer, a request for contact information associated with the electronic device and first provisioning data for the instance of the digital key;
receiving, associated with the relay computer, encrypted information specifying the contact information and the first provisioning data;
decrypting the encrypted information;
providing, addressed to a host computer, second contact information and input data for a hash function; and
selectively receiving, associated with the host computer, second provisioning data for the instance of the digital key.

12. The method of claim 11, wherein, after providing the contact information and the input data, and prior to receiving the second provisioning data, the method comprises performing a verification process with the host computer and a verification computer.

13. The method of claim 11, wherein, after receiving the second provisioning data, the method comprises creating the instance of the digital key based at least in part on the first provisioning data and the second provisioning data.

14. A host computer, comprising:
an interface circuit configured to communicate with an electronic device, a verification computer and a partner computer;
a processor coupled to the interface circuit; and
memory, coupled to the processor, storing program instructions, wherein, when executed by the processor, the program instructions cause the host computer to perform operations comprising:
receiving, associated with the electronic device, contact information and input data for a hash function;
performing a comparison operation based at least in part on an identifier of the electronic device and stored device information;
when there is a match between the identifier and the stored device information, considering the electronic device to be verified; and
when the electronic is considered to be verified:
generating a hashed version of the contact information based at least in part on the input data and the hash function;
providing, addressed to the partner computer, the hashed contact information and a request for the provisioning data;
selectively receiving, associated with the partner computer, the provisioning data; and
selectively providing, addressed to the electronic device, the provisioning data.

15. The host computer of claim 14, wherein the operations comprise, when there is not a match between the identifier and the stored device information, providing a request, addressed to the verification computer, with a one-time password to be provided to the electronic device, and receiving, associated with the electronic device, the one-time password that is then used by the host computer to verify the electronic device.

16. The host computer of claim 14, wherein the contact information comprises at least one of a telephone number or an email address.

17. The host computer of claim 14, wherein the input data comprises random or pseudorandom data.

18. The host computer of claim 14, wherein the instance of the digital key comprises a digital car key or a digital lock key.

19. The host computer of claim 14, wherein the partner computer may be associated with a manufacturer that provides the instance of the digital key.

20. The host computer of claim 14, wherein the host computer, the verification computer, or both are associated with a manufacturer or a provider of the electronic device.
